(19) United States
(12) Patent Application Publication
(10) Pub. No.: US 2013/0288224 A1
(43) Pub. Date: Oct. 31, 2013

(54) Display Device and Method

(71) Applicants: Carrie A. Soler, Deerfield Beach, FL (US); Daniel J. Santaniello, Boca Raton, FL (US)

(72) Inventors: Carrie A. Soler, Deerfield Beach, FL (US); Daniel J. Santaniello, Boca Raton, FL (US)

(73) Assignee: Mastermind Memory Technologies LLC, Baca Raton, FL (US)

(21) Appl. No.: 13/864,487

(22) Filed: Apr. 17, 2013

Related U.S. Application Data
(60) Provisional application No. 61/687,092, filed on Apr. 18, 2012.

(51) Int. Cl. G09B 5/00

(52) U.S. Cl. CPC G09B 5/00
USPC 434/429

(57) ABSTRACT

The display device and method uses a computer display device or “pad” mounted in a frame and positioned to be visible to observers. The computer device is programmed to display user-selected messages for user-selected time periods. Preferably, the frame is displayed in the seats behind the front seats of a motor vehicle so that the passengers can be given lessons to view for selected lengths of time to facilitate learning and memorization, and to keep the passengers occupied. The frame structure allows lesson cards and handwritten messages to be displayed when the computer device is absent from the frame.

This invention relates to display devices and methods, particularly for educational purposes, and particularly for displaying selected messages and/or visual representations in vehicles.

Display devices for educating students are in great demand. Devices for occupying children riding in vehicles also are in demand. Devices for performing both tasks simultaneously are particularly desirable. However, known devices available for such purposes are believed to be inadequate in many respects.

Therefore, it is an object of this invention to provide a versatile portable educational display device and method which overcome the inadequacies of the prior art, and providing such a display device that is compact, easy to use, and relatively inexpensive.

It is a further object to provide such a device and method of use for educating persons, particularly children, riding in rearwardly-located seats of a vehicle.

In accordance with the present invention, these objects are met by providing a support structure for a general-purpose computer display device, such as an “iPad” by Apple and programming for the computer display device which displays a series of one or more user-selectable messages, each for a predetermined, user-selectable time. The support structure will hold the computer display device where it easily can be seen by viewers who are being taught.

Preferably, the support device is adapted to be mounted in a vehicle to display messages to occupants, particularly children, sitting in the rearwardly-located areas or seats of the vehicle. In this manner, the passengers can be both occupied and educated while riding in the vehicle.

Preferably, a white-board or similar erasable surface is located behind the storage compartment for the computer display device so that hand-written messages can be displayed on the white-board instead of on the computer display device.

Alternatively, pre-formed “memory cards” can be stored in the support structure and displayed in place of the computer display device.

### IN THE DRAWINGS

FIGS. 1-3 are perspective views of the front seat of an automobile or other passenger vehicle with an attached display device in accordance with the present invention, each figure showing the display device in a different mode of operation;

FIG. 4 is a perspective view of an embodiment of the display device frame, without the computer display device and separated from the automobile seat of FIGS. 1-3;

FIGS. 5 and 6 are perspective views like FIG. 4 illustrating one of the operational features of the invention;

FIG. 7 is a front elevation view of a display device frame of the invention without a computer display device such as an iPad in position;

FIG. 8 is a front elevation view like that of FIG. 7;

FIG. 9 is a left side elevation view of the device shown in FIGS. 7 and 8; and

FIG. 10 is a rear elevation view of the device shown in FIGS. 7, 8 and 9.

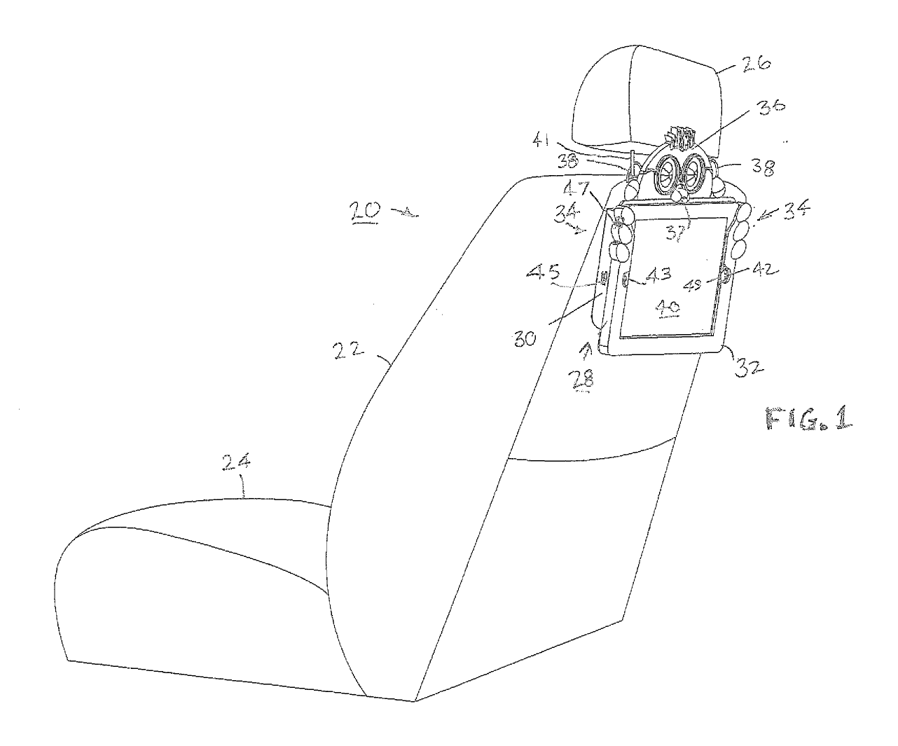

FIG. 1 shows the front seat 20 of a passenger vehicle with a back rest 22 and a seat portion 24, as well as a headrest 26. The position of the head rest is adjustable vertically on support rods 41. The seat 20 preferably is one which is used in the front of a motor vehicle, either by the driver or a passenger, but also can be an intermediate seat in a vehicle that has more than two rows of seats.

A display device 28 constructed in accordance with the invention is hung from two metal or plastic hooks 38 looped over the vertical support rods 41 for the head rest of the car.

The display device 28 has a rectilinear receptacle 30, a frame 32, with decorative elements 34 on the sides of the frame 32, and a further decorative element 36 extending upwardly. The decorative elements, in this case, are a portion of the head 36, the nose 37, and fingers 34 of a cartoon-like character.

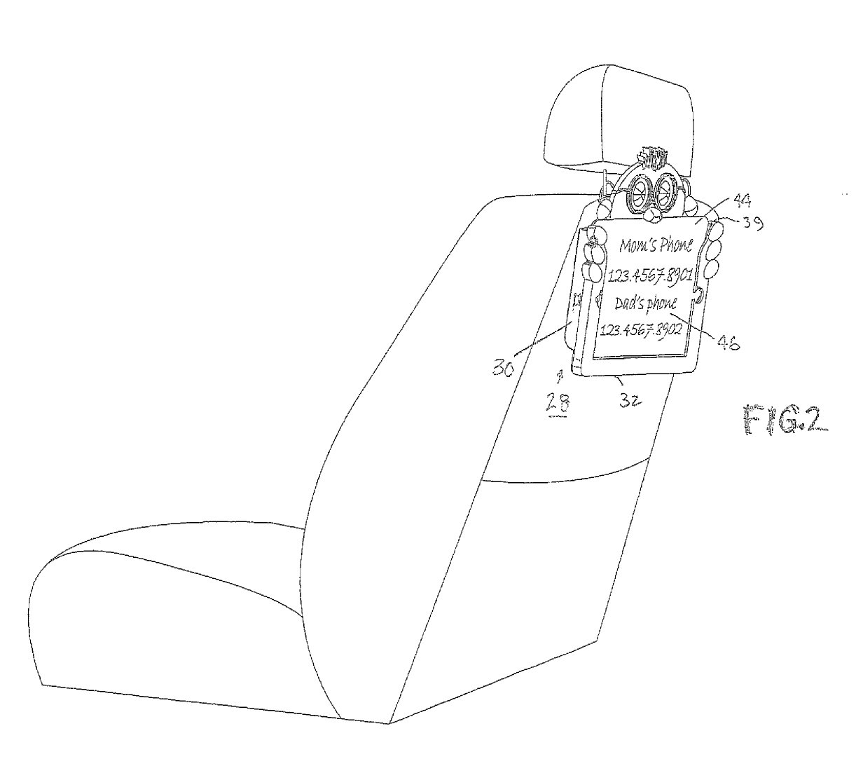

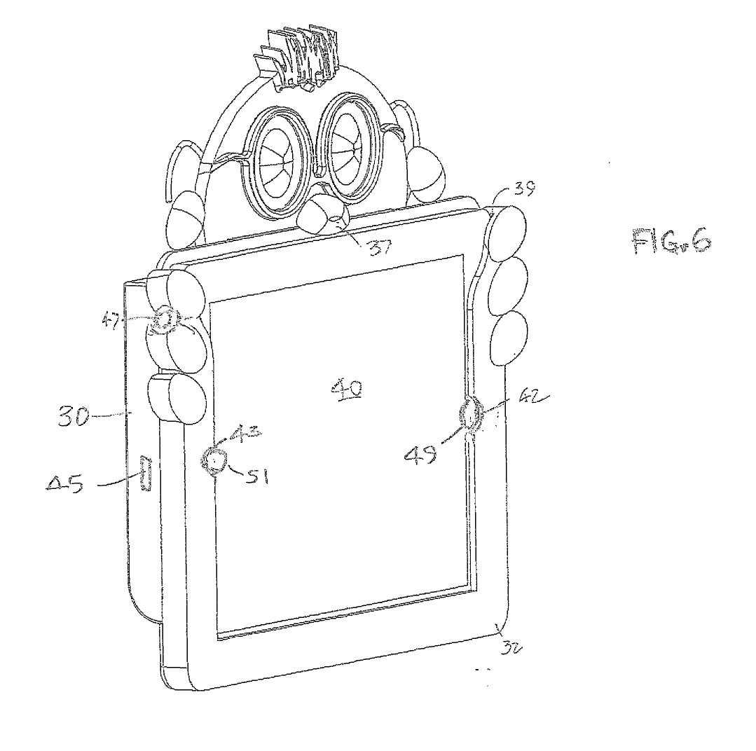

Fitted into a slot 39 (see FIGS. 2, 4, 5, 6, etc) of a suitable size and shape, is a computer display device 40 such as an “iPad” computer tablet or equivalent. The iPad device 40 is held in the slot 39 by a spring-loaded retainer member 37.

Holes and other means for controlling the computer device 40 are provided as desired or needed.

Preferably, the computer device 40 is touch-screen operated so that only a moderate number of control access ports are needed. A cut-out 42 (FIG. 1) is provided in the frame 32 to give access to the “home” button of the computer pad 40. Similarly, a cut-out 43 is provided to enable use of the front camera lens of the computer pad, an access opening 45 is provided to enable use of the microphone and a flexible on/off switch pad 49 is provided to enable switching the computer on or off without removing it from the frame.

FIG. 10 shows an access opening 55 in the frame housing 30 to enable use of the rear camera lens, and a receptacle access 57 for receiving a charging terminal for charging the batteries of the computer device 40.

FIGS. 1-3 show the display device 28 in use in its preferred location, where it can be seen by passengers, often children, sitting in the rearwardly-located seats of the vehicle, but is not visible to the driver in the front seat, so that she or he will not be distracted while driving.

FIG. 1 shows the display device 28 in one of several different modes of operation; namely, with an iPad or similar computer display device held in position for easy viewing by children or others in the rearwardly-located seats of the vehicle.

FIG. 2 shows the display device 28 in another form of operation. The computer pad 40 is removed and the rear wall 44 of the structure has a front surface which has a fixed of removable “white board” surface. Colored or black markers can be used by an adult wishing to give to the passenger's messages such as the message 46 written in the white board 44 shown in FIG. 2. The message written consists of the mother's and father's phone numbers. By displaying these numbers, children in the rear seat will be able to see the phone numbers continuously, and hopefully will memorize them.

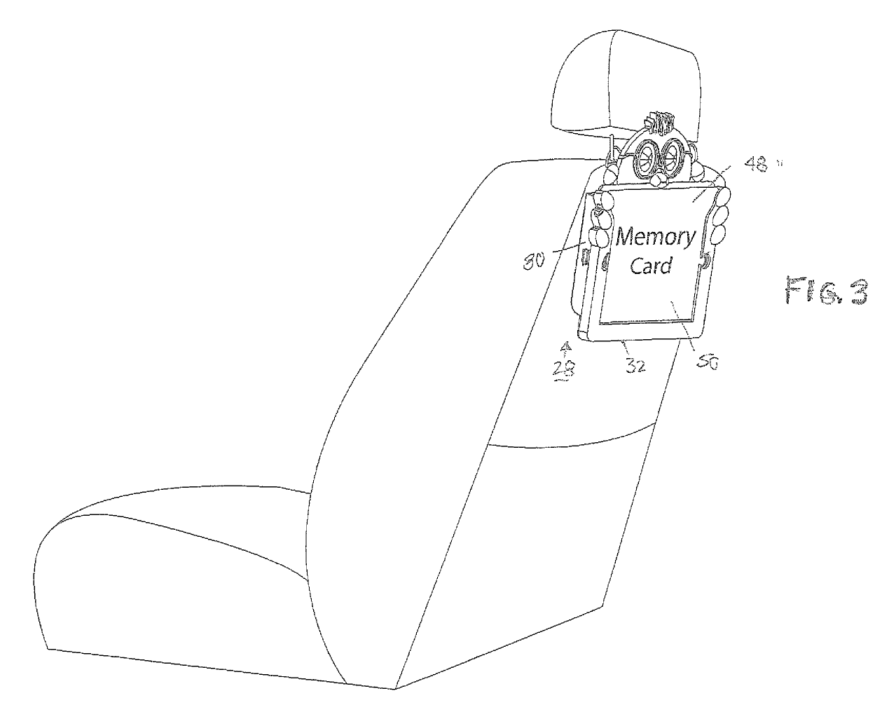

FIG. 3 shows the display device 28 with a memory card inserted into the slot 39 where the iPad or other computer display pad normally would reside. On the memory card 48 is printed a message such as “Memory card” shown in FIG. 3. The memory cards can be selected by the parent or the student from a supply stored in the bin 30, and removed from the bin and inserted into the slot 39 for display to the person or persons sitting in the seat behind the seat 20.

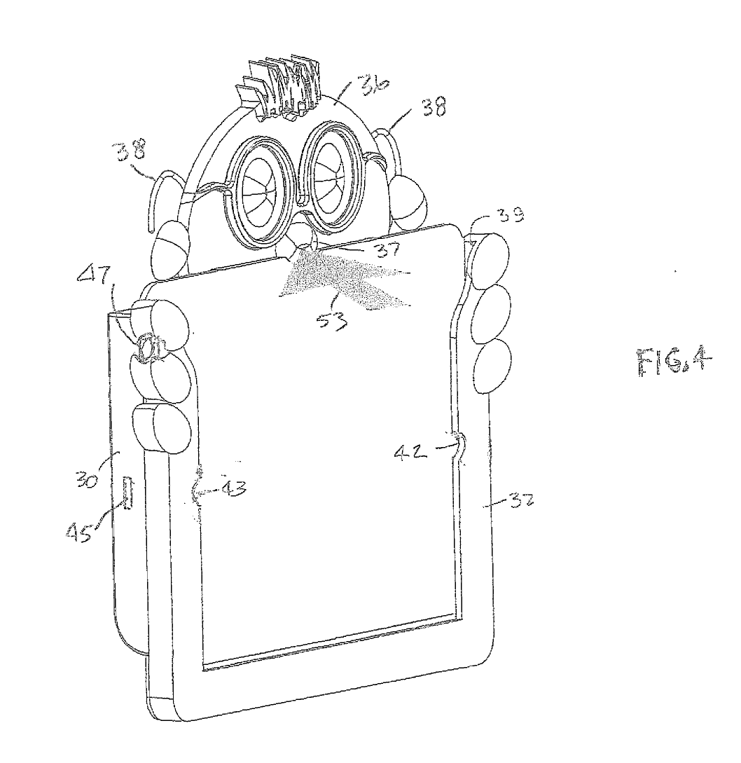

FIGS. 4, 5, and 6 illustrate how to insert an iPad or similar computer display device into the slot 39 in the support structure. First, the spring-loaded retainer 37 or latch in the form of a nose is depressed inwardly in the direction indicated by the arrow 53. The latch 37 is of the type which is held in the depressed position when it is pushed once, and is released to spring forward when pushed a second time.

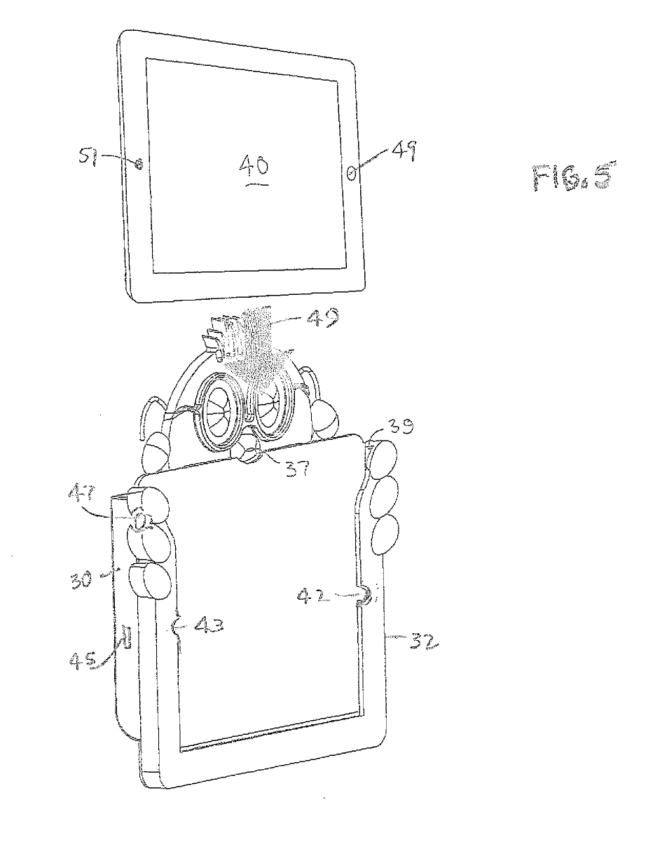

Next, as shown in FIG. 5, with the latch 37 depressed out of the way, the device 40 is inserted into the slot 39.

Finally, when the device 40 has moved downwardly past the latch member 37, and the latch is pushed again, the latch returns forwardly to its original forward position to securely hold the iPad device 40 in the holder.

The computer pad 40 can be removed from the display device 28 by reversing the above-described procedure.

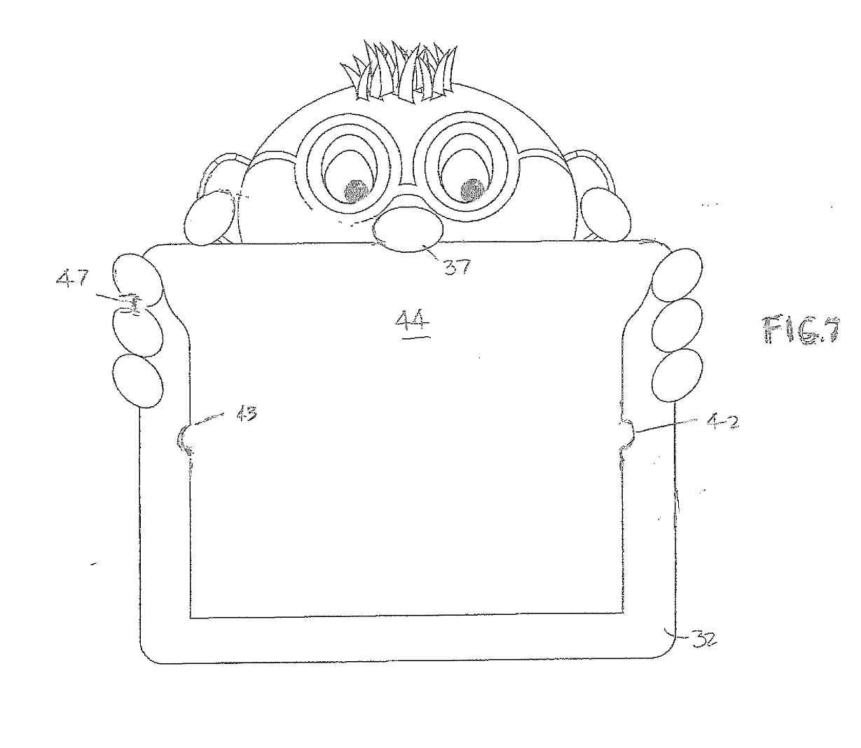

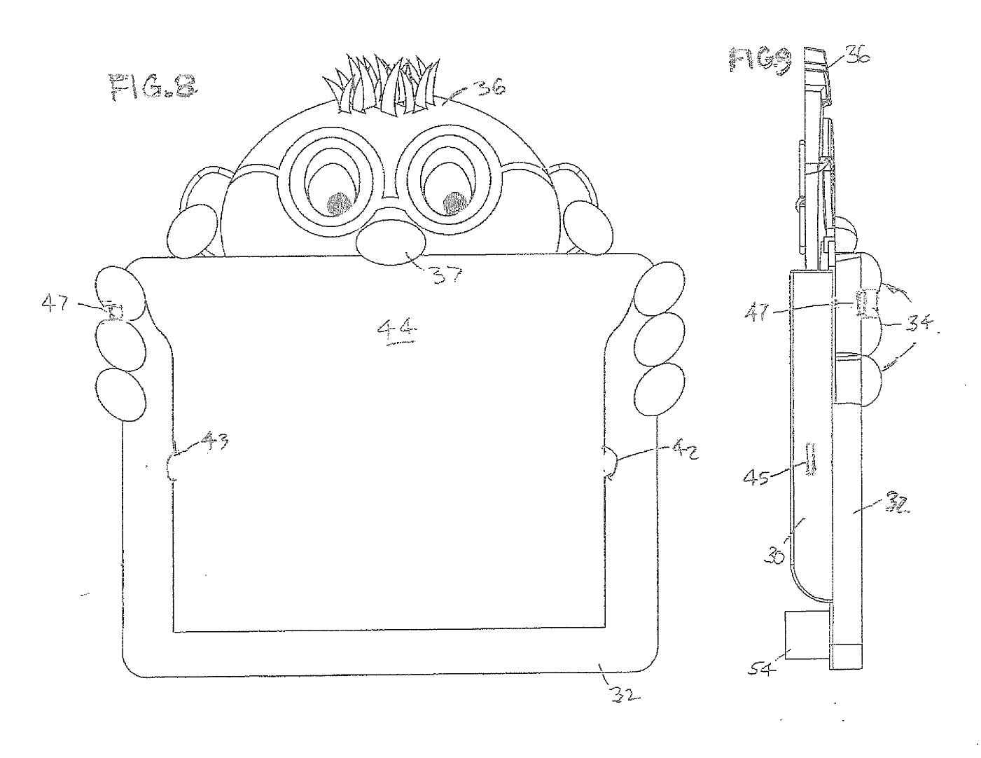

FIG. 7 shows the white board surface 44 forming a wall behind the space into which the computer display device fits, and FIG. 8 shows the same.

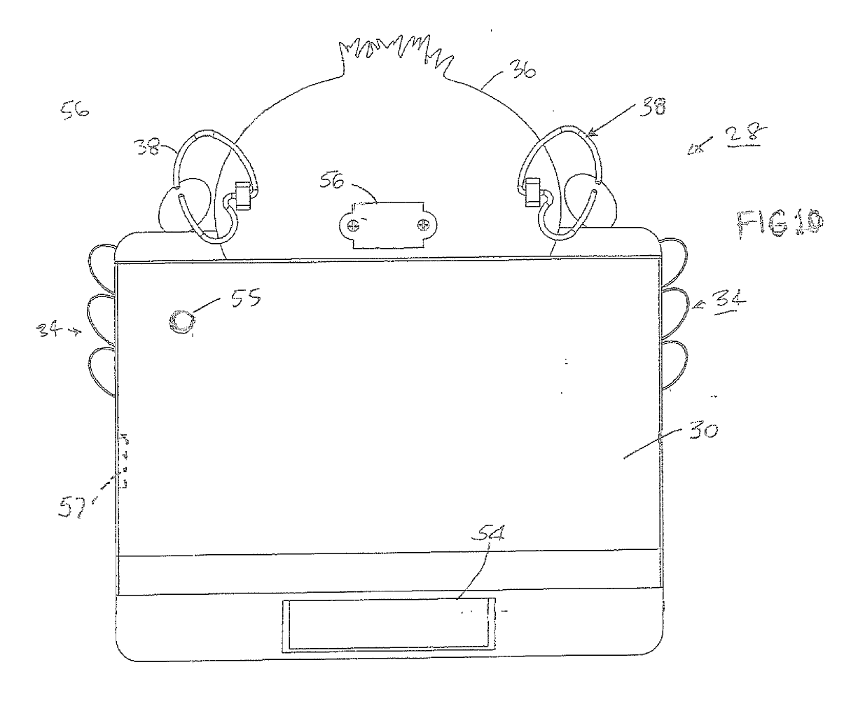

FIG. 9 is a left side elevation view of the device shown in FIG. 8.

FIG. 10 is a rear elevation view of the device 28 showing a spring cover 56 for the locking button 37, and showing the hanger hooks 38 in greater detail.

FIG. 10 also shows a pocket 54 provided for accessibly storing the marker and/or eraser for the white board.

### Programming and Operation

In accordance with a feature of the invention, an “app” (application program) is provided for the iPad or other computer display device for displaying user-selected messages for user-selectable periods of time.

The screens displayed by the program or app and the use of them is shown and described as follows.

Screen I is the first screen and is used to personalize the learning device.

Broadly speaking, the app permits the user (such as a parent) to store a series of messages in the computer memory, and then display each of the messages on the computer display screen for an amount of time the user wishes each message to be displayed.

This feature is highly advantageous in that it allows the given message to be displayed for substantial lengths of time which can be selected by the user to facilitate teaching the viewer, and memorization of important information. The message automatically changes after a selected amount of time.

For example, one particular message may be displayed for 5 minutes to ensure better memorization by the student, or for only 1 or 2 minutes, if the message is sufficiently easily memorized in that period of time, or for even less time, if memorization is not required.

Following are main features of the application for use with the Apple brand iPad and equivalent devices.

It should be emphasized that the display device of the invention can be used in surroundings other than a vehicle. The display device can be hung in a variety of locations, in school rooms, homes, and other locations for providing computer screen lesson displays of pre-selectable variable time duration, hand-written displays, and manually inserted lesson cards.

Wherever it is used, the invention provides displays where the students must see them, or are at least challenged to avoid seeing them.

Prepared text materials can be supplied with the application software to lessen the effort needed to prepare the materials for study.

The device and method of the invention facilitate learning languages by giving sustained vocabulary impressions.

Long-term memorization of tell is and useful information is provided while occupying the time of those with a temporary excess of time.

The display device also can be used for entertainment purposes—to display TV programs, “Pandora,” “Netflix” or other entertainment available through the use of the I-Pad and similar computer devices. It can be used with baby strollers or wheelchairs or other vehicles into which the occupants are confined, or with exercise devices and other such devices.

Although the invention has thus been shown and described with reference to specific embodiments, it should be noted that the invention is in no way limited to the details of the described arrangements but changes and modifications may be made without departing from the scope of the invention which is defined by the appended claims.

1. An educational device for utilizing a computer display device for delivering educational messages to students, said device comprising:
a. a frame for releasably holding a computer device with a flat display screen for viewing,
b. a support device for holding a said frame, and supporting said computer device in a desired location for presenting images to said students on said display screen,
c. said computer device being programmed to store user-selected messages for display on said screen, and to display each of said messages for a user-selected predetermined length of time.

2. A device as in claim 1 in which said frame has an erasable writing surface behind said computer device to permit marking and erasing of markings when said computer device is absent from said frame.

3. A device as in claim 1 in which said frame includes a receptacle for holding and displaying lesson cards and displaying said cards when said computer device is absent from said frame.

4. A device as in claim 1 in which said frame has an erasable writing surface behind said computer device to permit marking and erasing of markings when said computer device is absent from said frame, and in which said frame includes a receptacle for holding and lesson cards and displaying said cards when said computer device is absent from said frame.

5. A device as in claim 1 in which said computer display device is touch-screen operated and has a touch-screen accessible virtual keyboard for use in data entry.

6. A learning display device for use in a motor vehicle, said device comprising
a. a frame for releasably holding a computer device with a display screen for viewing in said vehicle,
b. a support device for supporting said computer device in said vehicle with said display showing in a back seat of said vehicle,
c. said computer device being programmed to store user-selected messages for display on said screen, and to display each of said messages for a user-selected predetermined length of time.

7. A device as in claim 6 in which said computer device has a relatively thin and wide shaped housing, and said frame has a slot for receiving said housing and a latch device for releasably holding said housing in said slot.

8. A display device as in claim 6 in which said frame has an erasable writing surface behind said computer device to permit the marking and erasing of markings when said computer device is absent from said frame.

9. A device as in claim 6 in which said frame has a compartment for releasably holding said computer device, and including a plurality of display cards, said compartment providing a holder for display of a selected one of said cards when said computer device is absent from said frame.

10. A method of occupying the time of and educating an occupant of a vehicle area behind a front seat of said vehicle, said method comprising:
a. providing a frame for releasably holding a computer device with a display screen for viewing in said vehicle,
b. providing a support device for supporting said computer device in said vehicle with said display showing in a back seat of said vehicle,
c. said computer device being programmed to store user-selected messages for display on said screen, and to display each of said messages for a user-selected predetermined length of time, and
d. causing said computer device to display said messages in a selected sequence and for said user-selected time for each message while said occupant is in said vehicle.

11. A method as in claim 10 in including a step selected from the group consisting of removing said computer device from said frame and omitting to insert said computer device into said frame, and
creating messages to be displayed by a step selected from the group consisting of writing them on an erasable back panel behind said computer device and inserting into said frame cards bearing pre-selected messages which are visible when so inserted.

12. A method as in claim 10 in which said selected messages are selected messages selected from the group consisting of phone numbers, addresses, names of family members, language vocabulary, and mathematics lessons.

13. A method as in claim 10 in which said providing step comprises providing a commercially available computer pad device, and said programming step comprises providing application software for said pad device, said software providing a template for entry of display data comprising a series of screens, together with the display time for each screen.

14. A method as in claim 10 in which said programming step includes providing application software for said computer device which causes the lessons and times of display to be accumulated separately for each student using said computer pad, and providing a display of the information so accumulated for each separate student.
